(19) United States
(12) Patent Application Publication
(10) Pub. No.: US 2009/0109139 A1
(43) Pub. Date: Apr. 30, 2009

(54) PLASMA DISPLAY PANEL DEVICE

(76) Inventors: Nobuyoshi Kondo, Kawasaki (JP); Takashi Sasaki, Hiratsuka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/197,345

(22) Filed: Aug. 25, 2008

(30) Foreign Application Priority Data
Oct. 29, 2007 (JP) 2007-280203

(51) Int. Cl. G09G 3/28

(52) U.S. Cl. 345/67; 345/60; 345/211

(57) ABSTRACT

A PDP device can realize both the reduction in power consumption in the sustain period and the appropriate erase operation. The PDP device has a plurality of display electrodes on a substrate surface, wherein the display electrodes include mutually adjacent X electrodes and Y electrodes. And the PDP has X, Y drive circuits that drive the X, Y electrodes. Further, in a sustain period, the X, Y electrode drive circuits apply sustain pulses having a rising dull waveform during the rise and a falling dull waveform during the fall between the X, Y electrodes a plurality of times, and after the plurality of sustain pulses have been applied, apply narrow erase pulses having a rise characteristic sharper than the rising dull waveform during the rise and also having a pulse width shorter than that of the sustain pulses between the X, Y electrodes.

### CROSS-REFERENCE TO RELATED APPLICATIONS

This application is based upon and claims the benefit of priority from the prior Japanese Patent Application No. 2007-280203, filed on Oct. 29, 2007, the entire contents of which are incorporated herein by reference.

### BACKGROUND OF THE INVENTION

The present invention relates to a plasma display panel device (PDP device), and more particularly to a PDP device with improved narrow pulse width erase in sustain operation.

PDP devices have attracted attention as large-screen flat displays. The conventional PDP device is provided with a plurality of display electrodes (X, Y electrodes) on a transparent substrate on the front surface side and has a plurality of address electrodes crossing the display electrodes and phosphors on the substrate on the rear surface side. In the display operation, a reset discharge is generated between the X, Y electrodes in a reset period, the state of wall charges on the panel is made uniform, the address electrodes are driven correspondingly to display data, while scanning the Y electrodes in the address period, an address discharge is generated between the Y electrodes and address electrodes, a wall charge necessary for the discharge during sustain is generated, and the predetermined number of sustain pulses are applied between the X, Y electrodes in the sustain period so that a predetermined number of sustain discharges are generated in the cells where the address discharge has occurred.

Reducing power consumption in the sustain period is one of the well-known problems associated with the PDP devices. In the sustain period, sustain pulses are applied multiple times between the adjacent X electrodes and Y electrodes. More specifically, sustain pulses of alternately inverted polarity are applied between the X, Y electrodes by applying the sustain pulses alternately to the X electrodes and Y electrodes. The voltage of such sustain pulses is, for example, as high as 200 V. Therefore, the power consumed in the sustain operation is very high.

In order to reduce the power consumption, the sustain drive circuits of X electrodes and Y electrodes have a power recovery circuit. The power recovery circuit has an LC resonance circuit, and the LC resonance circuit recovers the power from the panel when the sustain pulse ends, accumulates the electric charge in the capacitor, and supplies the electric charge accumulated in the capacitor to the panel when the sustain pulse is started. Therefore, the waveform of the sustain pulse has a dull waveform for supplying the power when the pulse rises and a dull waveform for recovering the power when the pulse falls. Such a power recovery circuit is described, for example, in Japanese Patent Application Laid-open No. 2006-154287.

On the other hand, in the PDP, a sustain discharge is generated in the sustain period only in the cells that have been ignited in the address period. Upon completion of the sustain discharge, a state is assumed in which an electric charge (residual charge) is accumulated on the surface of X, Y electrodes in the ignited cells. Accordingly, in the reset period that follows the sustain period, reset pulses having a very high voltage are applied to the X, Y electrodes, a reset discharge is induced in all the cells including ignited cells and non-ignited cells, and the state of residual charges on the panel is made uniform.

However, because a very large amount of residual electric charges are present on the X, Y electrodes when the sustain period ends, a narrow erase pulse that has a pulse width less than that of the sustain pulse is applied at the very end of the sustain period and narrow erasure is performed to decrease the amount of residual electric charges in the cells subjected to sustain discharge. For example, Japanese Patent Applications Laid-open No. 2005-173626 and 2006-189847 describe narrow erasure performed in the sustain period.

### SUMMARY OF THE INVENTION

As described hereinabove, a power recovery circuit composed of an LC resonance circuit is provided in the sustain drive circuit to reduce power consumption in the sustain period, the power is recovered from the panel by the LC resonance circuit as the sustain pulse falls, and the power is supplied by the LC resonance circuit to the panel as the sustain pulse rises. Accordingly, the waveform of sustain pulse is a dull waveform at the rise and fall sections. Further, a narrow erase pulse has to be applied to the X or Y electrodes when the sustain period ends, and the amount of residual electric charge on the X, Y electrodes has to be reduced.

However, the problem is that where the rise waveform of the narrow erase pulse becomes a dull waveform due to the operation of the power recovery circuit, there is a spread in the magnitude of erase discharge between the cells due to the spread in characteristics between a plurality of cells within the panel. The dull waveform during the rise gradually increases the voltage between X, Y, and the erase discharge is successively started from the cells in which the discharge threshold has been exceeded. In the cells in which the start of erase discharge is delayed by the spread in cell characteristics, a sufficient erase discharge is not generated by the narrow erase pulse and the amount of residual electric charges cannot be reduced sufficiently.

Accordingly, it is an object of the present invention to provide a PDP device in which both the reduction in power consumption in the sustain period and the appropriate erase operation can be realized.

In order to resolve the above-described problems, according to the first aspect of the present invention there is provided a PDP device having a plurality of display electrodes on a substrate surface, wherein the display electrodes include mutually adjacent X electrodes and Y electrodes (second, first electrodes), and the PDP has X, Y drive circuits that drive the X, Y electrodes. Further, in a sustain period, the X, Y electrode drive circuits apply sustain pulses having a rising dull waveform during the rise and a falling dull waveform during the fall between the X, Y electrodes a plurality of times, and after the plurality of sustain pulses have been applied, apply narrow erase pulses having a rise characteristic sharper than the rising dull waveform during the rise and also having a pulse width shorter than that of the sustain pulses between the X, Y electrodes.

According to the above-described first aspect of the present invention, the X, Y drive circuits have a power recovery circuit composed of an LC resonance circuit, and the LC resonance circuit recovers electric charges located between the X, Y electrodes when the sustain pulse falls and then supplies the recovered electric charges between the X, Y electrodes when the sustain pulse rises, whereby the power consumption is reduced. Further, the rise characteristic of the narrow erase pulse after a plurality of sustain pulses have been applied is made sharper than the rising dull waveform so that the uniform erase discharge is generated, regardless of the spread in characteristics between the cells.

According to the above-described first aspect of the present invention, the X, Y drive circuits have, in addition to the power recovery circuit, a clamp circuit that applies a predetermined clamp voltage between the X, Y electrodes. Further, the X, Y drive circuits apply a rising dull waveform voltage with operating the power recovery circuit between the X, Y electrodes during the rise of the sustain pulse, then apply the clamp voltage with operating the clamp circuit, apply a falling dull waveform voltage with operating the power recovery circuit during the fall, and then remove the clamp voltage of the clamp circuit. Further, the X, Y drive circuits apply the clamp voltage with operating the clamp circuit between the X, Y electrodes during the rise of the narrow erase pulse. During the fall of the narrow erase pulse, the falling dull waveform voltage is applied by the power recovery circuit and then the clamp voltage may be removed by the clamp circuit or the clamp voltage may be removed without applying the falling dull waveform voltage.

In order to resolve the above-described problems, according to the second aspect of the present invention there is provided a plasma display panel device having a plurality of display electrodes on a substrate surface, the display electrodes including first electrodes and second electrodes adjacent to each other, comprising:

a first electrode drive circuit that drives the first electrodes; and

a second electrode drive circuit that drives the second electrodes, wherein

in a sustain period, the first and second electrode drive circuits alternately apply sustain pulses having a rising dull waveform during the rise and a falling dull waveform during the fall to the first and second electrodes, and

after the sustain pulses have been applied to the second electrodes, the first electrode drive circuit applies, to the first electrodes, narrow erase pulses having a rise characteristic sharper than the rising dull waveform during the rise and also having a pulse width shorter than that of the sustain pulses.

In order to resolve the above-described problems, according to the third aspect of the present invention there is provided a plasma display panel device having a plurality of display electrodes on a substrate surface, the display electrodes including first electrodes and second electrodes adjacent to each other, comprising:

a first electrode drive circuit that drives the first electrodes; and

a second electrode drive circuit that drives the second electrodes, wherein

in a sustain period, the first and second electrode drive circuits alternately apply sustain pulses having a rising dull waveform during the rise and a falling dull waveform during the fall to the first and second electrodes, and

after the sustain pulses have been applied to the second electrodes, the first electrode drive circuit applies a first erase pulse having a rise characteristic sharper than the rising dull waveform to the first electrodes at a first time, and the second electrode drive circuit applies a second erase pulse of the same polarity as the first erase pulse to the second electrodes at a second time after a time shorter than a pulse width of the sustain pulse has elapsed from the first time.

Because the narrow erase pulse that is applied between the X, Y electrodes at the completion of the sustain period has a rise characteristic sharper than the rise dull waveform of the sustain pulse, an erase discharge can be generated in all the ignited cells, regardless of the spread in cell characteristics, when the narrow erase pulse is applied, so that the residual electric charges of the ignited cells can be reduced with a small spread.

### BRIEF DESCRIPTION OF THE DRAWINGS

FIG. 1 is a structural diagram of the entire PDP device of the present embodiment.

FIG. 2 is a panel sectional view of the PDP device.

FIG. 3 is a drive waveform diagram of the PDP device.

FIG. 4 illustrates a state of residual electric charges of selected cells in the sustain period.

FIG. 5 shows a specific circuit diagram of the sustain driver circuit in the present embodiment.

FIG. 6 shows a waveform of control pulses of the sustain driver circuit 16.

FIG. 7 shows a waveform of a sustain pulse in the present embodiment.

FIG. 8 shows a state of residual electric charges affected by the erase pulse.

FIG. 9 shows a waveform of the second sustain pulse in the present embodiment.

FIG. 10 shows a waveform of the third sustain pulse in the present embodiment.

### DETAILED DESCRIPTION OF PREFERRED EMBODIMENTS

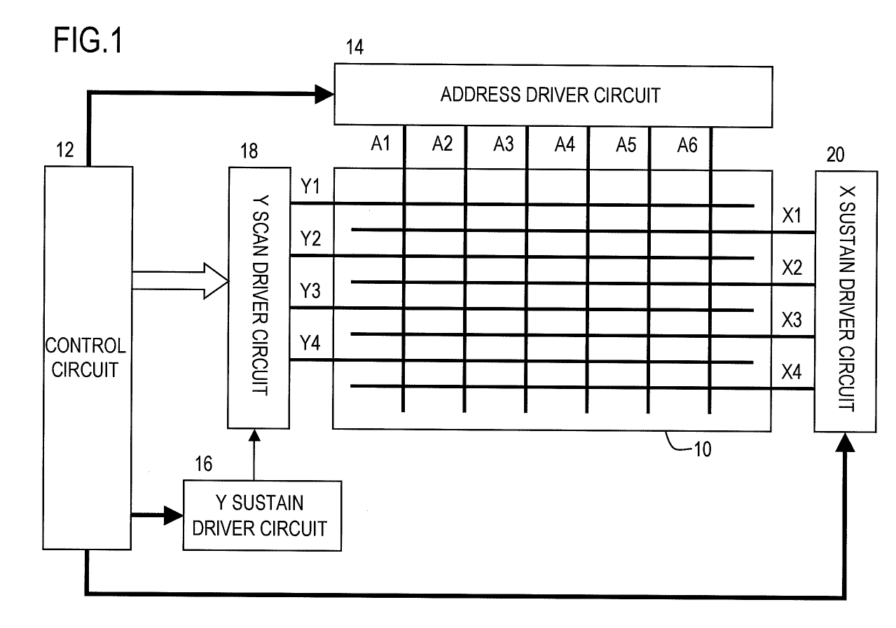

FIG. 1 is a structural diagram of the entire PDP device of the present embodiment. A panel 10 has a transparent substrate on the front surface side and a substrate on the rear surface side, and a discharge space with a discharge gas sealed therein is formed between the front surface substrate and rear surface substrate. A plurality of display electrodes X1 to X4, Y1 to Y4 extending in the horizontal direction are formed on the front surface substrate. The display electrodes have mutually adjacent X electrodes (second electrodes) X1 to X4 and Y electrodes (first electrodes) Y1 to Y4. A plurality of address electrodes A1 to A6 that extend in the vertical direction and cross the display electrodes are provided on the rear surface substrate. Cells are formed at the intersection positions of the X, Y electrodes and address electrodes.

In addition to the panel 10, the PDP comprises an address driver circuit 14 that drives address electrodes correspondingly to the display data in an address period, an X sustain driver circuit 20 that drives the X electrodes, which are display electrodes, and an Y sustain driver circuit 16 that drives the Y electrodes, which are display electrodes. The X, Y sustain driver circuits 20, 16 apply sustain pulses to the X, Y electrodes in a sustain period. Further, the PDP device has an Y scan driver circuit 18 that scans the Y electrodes in the address period. Further, a control circuit 12 is supplied with display video data, supplies display data to the address driver circuit 14, supplies scan control signals to the Y scan driver circuit 18, and supplies sustain control signals to the X, Y, sustain driver circuits 20, 16.

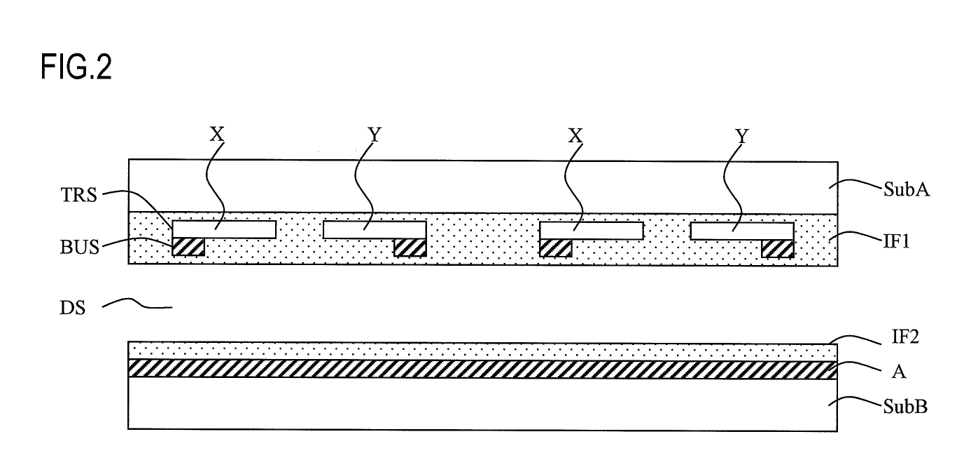

FIG. 2 is a panel sectional view of the PDP device. This figure is a cross-sectional view along address electrodes. A transparent substrate SubA on the front surface side and a substrate SubB on the rear surface side sandwich and seal a discharge space DS. The discharge gas is sealed in the discharge space DS. A plurality of X, Y electrodes are formed alternately on the substrate SubA on the front surface side. The X, Y electrodes are composed of a transparent electrode TRS composed, for example, of ITO (indium tin oxide film) and a metal bus electrode BUS composed of Cr/Cu/Cr and are coated with a dielectric layer IF1. A protective layer composed of MgO (not shown in the figure) is formed on the surface of the dielectric layer IF1. Address electrodes A composed of a metal are formed on the substrate SubB on the rear surface side and covered with a dielectric layer IF2.

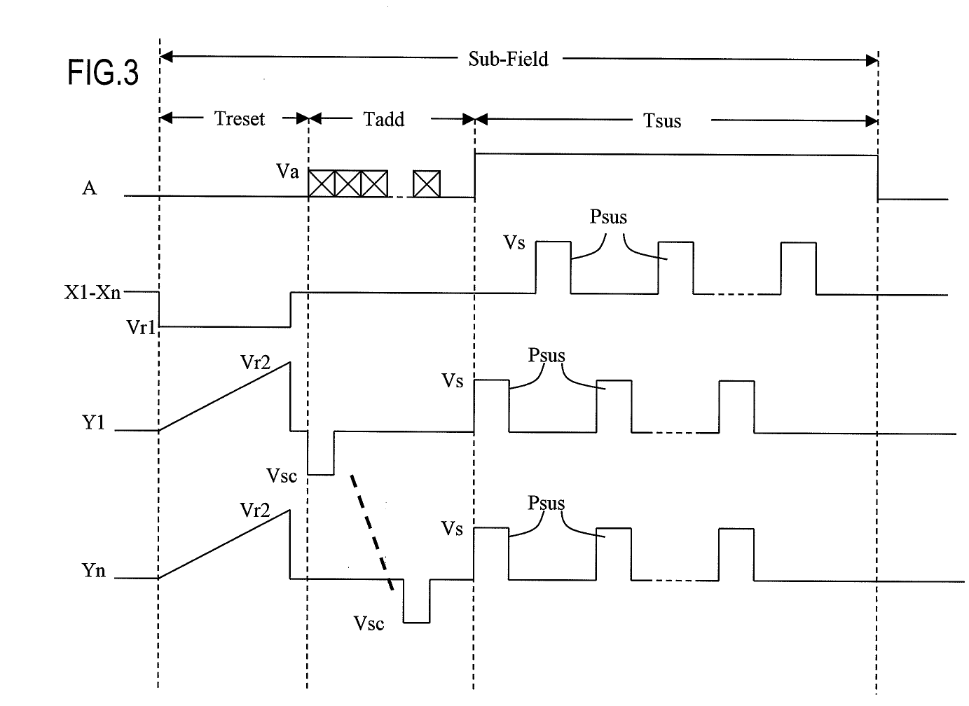

FIG. 3 is a drive waveform diagram of the PDP device. FIG. 3 shows the example of drive waveforms of address electrodes A, X electrodes X1-Xn, and Y electrodes Y1-Yn. The drive of the PDP device is performed by dividing one field period into a plurality of subfields Sub-Field. FIG. 3 shows a drive waveform of one subfield period.

Each subfield has a reset period Treset, an address period Tadd, and a sustain period Tsus. In the reset period Treset, a reset voltage Vr1 of negative polarity is applied to all the X electrodes X1 to Xn, while a gradually rising lamp voltage Vr2 of positive polarity is applied to all the Y electrodes Y1 to Yn. As a result, a reset discharge is generated in all the cells, and an erase discharge for electric charge adjustment is generated in all the cells when the application of the lamp voltage Vr2 is completed.

In the address period Tadd that follows the reset period Treset, the X sustain driver circuit 20 maintains all the X electrodes at a ground potential, and in this state the Y scan driver circuit 18 scans the Y electrodes, while successively applying the scan pulses Vsc of negative polarity to the Y electrodes, and the address driver circuit 14 applies a voltage (0V or Va) corresponding to display data to the address electrodes A synchronously with this scan timing. As a result, an address discharge is generated between Y-A and X-Y in the selected cells, and negative and positive residual electric charges are formed on the dielectric layer on top of the X electrodes and Y electrodes, respectively.

Then, in the sustain period Tsus, sustain pulses are applied between the X, Y electrodes. The polarity of sustain pulses applied between the X, Y electrodes changes alternately. More specifically, as shown in FIG. 3, all the X electrodes are initially set to a ground potential, a sustain pulse Vs having a voltage of Vs is applied to all the Y electrodes, and pulses of negative polarity are applied between X, Y electrodes. At this time, because negative and positive residual electric charges have been formed on the dielectric layer on top of the X electrodes and Y electrodes, respectively, in the selected cells at the completion of address period, a sustain discharge is generated in the selected cells by the application of such sustain pulse, and positive and negative residual electric charges are formed on the dielectric layer on top of the X electrodes and Y electrodes, respectively. Since no residual charge is formed in a non-selected cell, the sustain discharge is not generated even when the sustain pulse is applied.

Then, all the Y electrodes are set to the ground potential, sustain pulses Vs having a voltage of Vs are applied to all the X electrodes, and pulses of positive polarity are applied between the X, Y electrodes. At this time, because, positive and negative residual electric charges have been formed on the dielectric layer on top of the X electrodes and Y electrodes of the selected cells at the point of time the immediately preceding sustain pulse has ended, a sustain discharge is generated in the selected cells by the application of the sustain pulse, and negative and positive residual electric charges are formed on the dielectric layer on the X electrodes and Y electrodes, respectively. In other words, a sustain discharge of a polarity reversed with respect to that of the initial sustain pulse application is generated between the X, Y electrodes.

The aforementioned sustain discharges are alternately induced between X, Y electrodes, the number of the discharges being equal to that of sustain pulses. The number of sustain pulses is set to a predetermined ratio for each subfield, and the desired display luminance is produced in each cell by the subfield combination.

Immediately after the sustain period Tsus, all the X electrodes are set to the ground potential, and a narrow erase pulse (not shown in the figure) that has a pulse width narrower than that of the sustain pulse and has a voltage value equal to that of the sustain pulse is applied to all the Y electrodes. The amount of residual electric charges on the X, Y electrodes is reduced by the application of the narrow erase pulse.

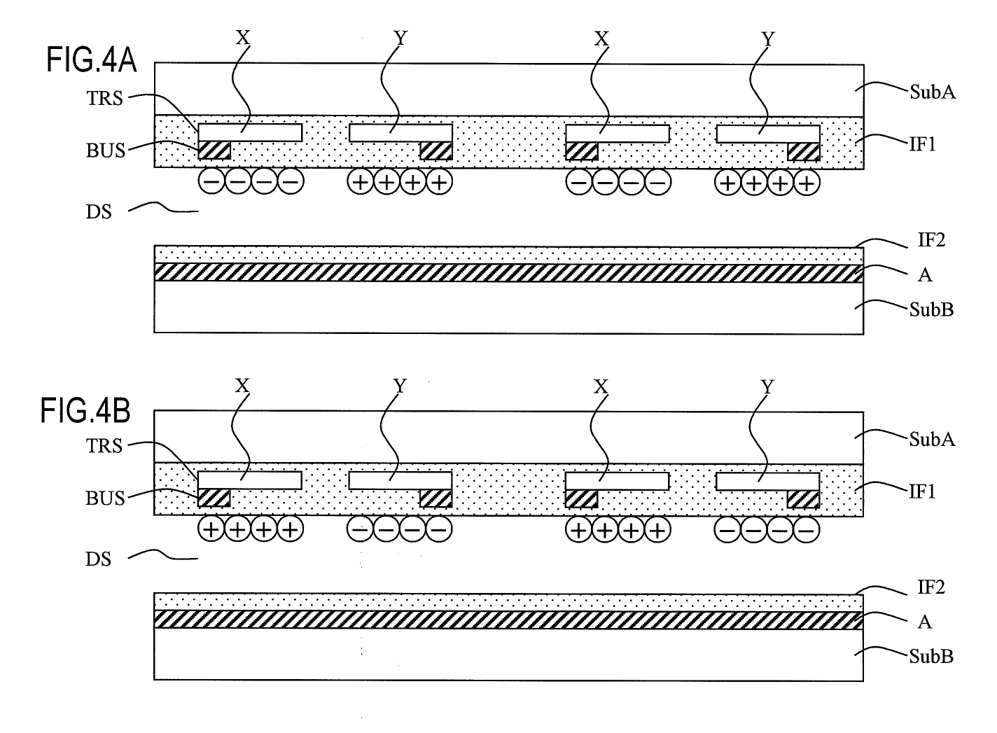

FIG. 4 illustrates a state of residual electric charges of selected cells in the sustain period. FIG. 4A shows a state upon completion of the address period, that is, at the initiation of the sustain period. In the address period, a negative scan pulse is applied to the Y electrodes, an address discharge is generated between the address electrodes and Y electrodes, and the address discharge is also generated between the X electrodes and Y electrodes. Because the X electrode side is at the ground potential (or positive potential) and Y electrode side is at a negative potential, the positive electric charges generated in the discharge space are drawn onto the Y electrodes and the positive electric charges are drawn onto the X electrodes, and the electric charges of the two types are accumulated as residual electric charges.

Where a sustain pulse of positive polarity is applied to the Y electrodes in the state shown in FIG. 4A, a sustain pulse discharge is generated. As a result, because the X electrode side is at the ground potential and the Y electrode side has a positive potential, as shown in FIG. 4B, the positive electric charges generated in the discharge space are drawn onto the X electrodes, the negative electric charges are drawn onto the Y electrodes, and the electric charges of two types are accumulated as residual electric charges.

Then, sustain pulses are alternately applied to all the X electrodes and all the Y electrodes, and a state shown in FIGS. 4A and B is alternately repeated.

The aforementioned sustain discharge can be also explained in the following manner. Where a positive sustain voltage Vs is applied to the Y electrode in the state shown in FIG. 4A, the positive electric charges remaining on the dielectric layer IF1 are repulsed thereby and move into the discharge space, the negative electric charges remaining on the dielectric layer IF1 of the X electrode are attracted by the positive voltage of the Y electrode and move into the discharge space where the positive and negative electric charges are coupled, and a sustain discharge is generated. Because the sustain voltage has been applied, the positive electric charges located within the discharge space are drawn onto the X electrodes, the negative electric charges are drawn onto the Y electrodes, and the state shown in FIG. 4B is obtained.

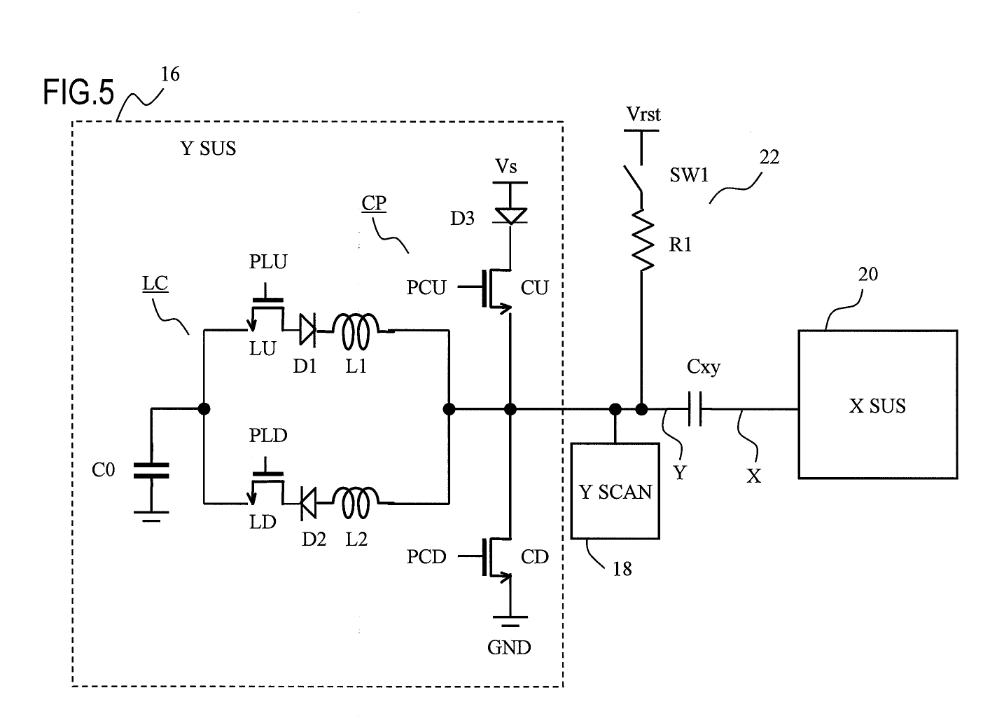

FIG. 5 shows a specific circuit diagram of the sustain driver circuit in the present embodiment. The Y sustain driver circuit 16 that drives the Y electrodes has a power recovery circuit LC having an LC resonance circuit and a clamp circuit CP that clamps the Y electrodes to the sustain voltage Vs. The power recovery circuit LC has a capacitor C0 for electric charge accumulation, a switch LD composed of an inductance L2, a diode D2, and an NMOS transistor and serving for power recovery between the Y electrode Y and the capacitor C0 for electric charge accumulation, a switch LU composed of an NMOS transistor for power supply, a diode D1, and an inductance L1. The clamp circuit CP has a switch CU composed of an NMOS transistor that applies the sustain voltage Vs to the Y electrode and a switch CD composed of an NMOS transistor that applies the ground potential to the Y electrode and removes the sustain voltage Vs. A diode D3 for preventing reverse current is provided between the switch CU and sustain voltage Vs.

The X sustain driver circuit 20 that drives the X electrodes is configured similarly to the Y sustain driver circuit 16.

FIG. 5 also shows a reset driver circuit 22 for applying a lamp pulse Vr2 to the Y electrode Y in the reset period. The reset driver circuit 22 has a switch SW1 connected to the reset voltage Vr2 and a resistor R1 acting as a delay element for forming a lamp pulse. Where the switch SW1 is closed in the reset period, a lamp pulse of positive polarity is applied to the Y electrode. In this case, a diode D3 is provided so as to prevent the electric current from flowing back to the side of the sustain voltage Vs via a parasitic diode (not shown in the figure) of the transistor CU.

Respective control pulses PLU, PLD, FCU, PCD are supplied from the control circuit 12 to the four switches LU, LD, CU, CD of the Y sustain driver circuit 16, and ON/OFF control is performed at the desired timings.

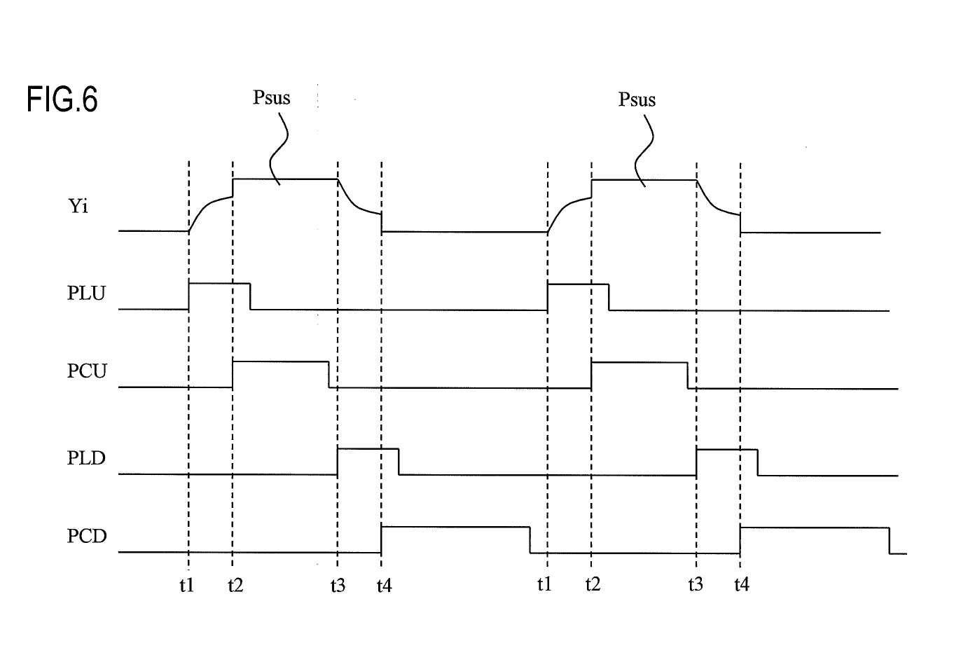

FIG. 6 shows a waveform of control pulses of the sustain driver circuit 16. At the application start timing t1 of the sustain pulse Psus, the control pulse PLU is at an H level, and an electric current flows through the switch LU. As a result, the electric charges that have accumulated within the capacitor C0 for electric charge accumulation are supplied to a parasitic capacitor Cxy between the Y, X electrodes via the switch LU, diode D1, and inductance L1. Because of characteristics of the LC resonance circuit composed of the inductance L1 and parasitic capacitor Cxy, the voltage of the Y electrodes Yi (i=1 to n) rises as a dull waveform. Further, at a time t2, the control pulse PCU assumes an H level, an electric current flows through the switch CU, and the sustain voltage Vs is applied to the Y electrode, as a result, the Y electrode is clamped to the sustain voltage Vs. At this time, the energy accumulated in the inductance L1 is released by a diode circuit (not shown in the figure) to the power source.

At a time t3 after the pulse width of the predetermined sustain pulse, the control pulse PLD assumes an H level, and an electric current flows through the switch LD. As a result, the electric charges accumulated in the parasitic capacitor Cxy are recovered into the capacitor C0 for electric charge accumulation via the inductance L2, diode D2, and switch LD. Because of characteristics of the LC resonance circuit composed of the inductance L2 and parasitic capacitor Cxy, the voltage of the Y electrodes Yi falls as a dull waveform. Further, at a time t4, the control pulse PCD assumes an H level, an electric current flows through the switch CD, and a ground potential GND is applied to the Y electrode. As a result, the sustain voltage Vs is deleted from the Y electrode. At this time, the energy accumulated in the inductance L2 is released by a diode circuit (not shown in the figure) to the power source.

The capacitor C0 for electric charge accumulation has a capacity enabling it to accumulate a sufficiently large electric charge. Therefore, as the above-described power recover operation and power supply operation are repeated, a sufficiently large electric charge is accumulated.

Thus, by providing a power recovery circuit LC within the sustain driver circuit 16, it is possible to a design the transistor switches CU, CD of the clamp circuit CP with a small current supply capacity, so that the transistor size can be reduced. Further, because the power recovery circuit LC makes it possible to recover and supply electric charges of a plurality of cells on the panel, power consumption can be reduced.

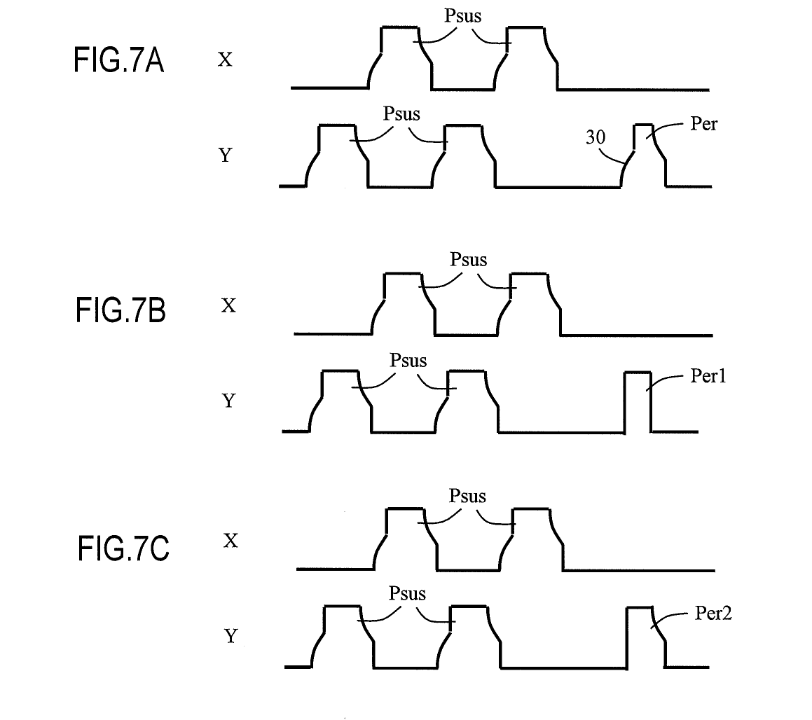

FIG. 7 shows a waveform of a sustain pulse in the present embodiment. The X, Y sustain driver circuits 16, 18 of the present embodiment have the sustain clamp circuit CP and power recovery circuit LC. Accordingly, the sustain pulse Psus has a dull waveform rise characteristic and a dull waveform fall characteristic. By using the power recovery circuit LC, it is possible to inhibit power consumption.

Further, after the predetermined number of sustain pulses Psus have been applied to the X, Y electrodes in the sustain period, a narrow erase pulse Per that has a pulse width less than that of the sustain pulse Psus, but the same voltage is applied to the Y electrodes. By applying this narrow erase pulse Per, it is possible to reduce the residual electric charge present on the X, Y electrodes.

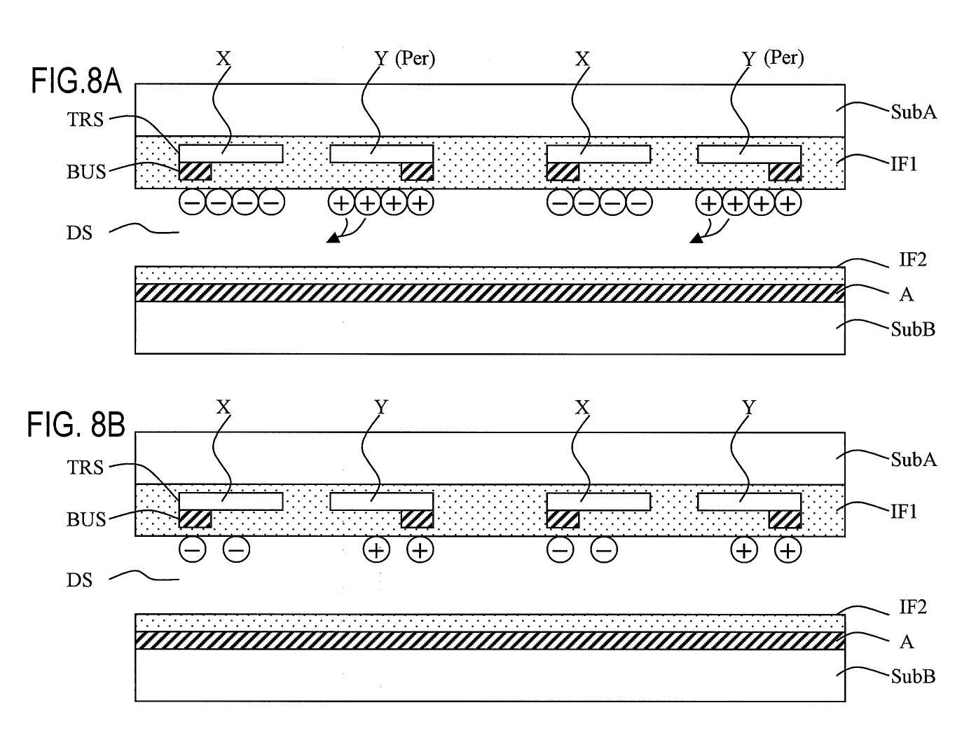

FIG. 8 shows a state of residual electric charges affected by the erase pulse. FIG. 8A shows a state after the very last sustain pulse Psus has been applied to the X electrodes, this state being identical to that shown in FIG. 4A. Negative electric charges remain on the dielectric layer IF1 on the X electrodes, and positive electric charges remain on the dielectric layer IF1 on the Y electrodes.

Where the narrow erase pulse Per of positive polarity and a short pulse width is applied to the Y electrodes in this state, the positive electric charges present on the Y electrodes are repulsed and burst out into the discharge space DS, the negative electric charges present on the X electrodes are drawn in and burst out into the discharge space DS, and the electric charges of two types are coupled, creating an erase discharge. However, because the pulse width of the narrow erase pulse Per is less than that of the sustain pulse Psus, only some of electric charges present on the X, Y electrodes burst out into the discharge space and are coupled. As a result, as shown in FIG. 8B, when the application of the narrow erase pulse Per is completed, the amount of residual electric charges on the dielectric layer IF1 upon the X electrodes and the amount of residual electric charges on the dielectric layer IF1 on the Y electrodes are reduced by comparison with those before the application of the narrow erase pulse.

In other words, the application of narrow erase pulse can reduce the residual electric charges generated by the sustain discharge. As a result, a reset discharge can be generated in all the cells in the subsequent reset period, and a charge adjustment discharge that follows it can be generated.

However, the following problem arises when the power recovery circuits of X, Y sustain driver circuits 20, 16 are actuated and the narrow erase pulse Per rises as a rising dull waveform 30. The rising dull waveform 30 gradually increases the voltage between the X, Y electrodes and generates a very small discharge when this voltage exceeds a cell discharge threshold voltage. Once the very small discharge is generated, the amount of electric charges present on the X, Y electrodes decreases, the voltage between the X, Y electrodes decreases, and the very small discharge stops. Where the voltage between the X, Y electrodes is further increased by rising dull waveform 30, the very small discharge is generated again.

Thus, because of the rising dull waveform of the narrow erase pulse Per, the discharge start timing changes according to the operation characteristic of the cell. As a result, due to the spread of operation characteristics of a plurality of cells, the magnitude of the erase discharge differs among the cells and the amount of residual electric charges in the selected cells cannot be reduced uniformly.

In the present embodiment, in order to resolve this problem and attain both the reduction of consumed power and the adequate erase operation, in the sustain period, the X, Y sustain driver circuits apply the sustain pulses Psus having a rising dull waveform during the rise and a falling dull waveform during the fall between the X, Y electrodes a plurality of times and then apply the narrow erase pulses Per1, Per2 having a rise characteristic sharper than the rising dull waveform during the rise and also having a pulse width shorter than that of the sustain pulses between the X, Y electrodes.

More specifically, as shown in FIG. 7B, the sustain pulse Psus that is alternately applied to the Y electrodes and X electrodes has a rising dull waveform and a falling dull waveform and uses a power saving effect produced by the power recovery circuit. On the other hand, after a plurality of sustain pulses Psus have been applied, a narrow erase pulse Per1 that is applied at the very end of the sustain period is made a pulse that rises and falls sharply, that is, a rectangular pulse. As a result, even when the operation characteristics of the cells have a spread, a strong discharge induced by the erase pulse having the sharp rise characteristic is generated in the erase discharge process, and the erase discharge is generated in all the selected cells.

Further, as shown in FIG. 7C, the narrow erase pulse Per2 that is applied at the very end of the sustain period is made a pulse that rises sharply and falls slowly. As a result, even when the operation characteristics of the cells have a spread, a strong discharge induced by the application of the erase pulse having the sharp rise characteristic is generated, and the erase discharge is generated in all the selected cells. Moreover, because the electric charge is recovered with the power recovery circuit as the pulse falls, a contribution can be made to the reduction of power consumption.

Because a strong discharge created by the sharp rise characteristic of the narrow erase pulse occurs only once in each subfield Sub-Field, the increase in power consumption caused thereby is not a significant problem.

The formation of the narrow erase pulses Per1, Per2 will be described below with reference to FIG. 6. Referring to FIG. 6, the operation of the power recovery circuit LC is stopped by holding the control pulses PLU and PLD at an L level. By switching the control pulses PCU, PCD to an H level at timings t2, t4, it is possible to generate on the Y electrodes by the clamp circuit CP a narrow erase pulse Per1 that rises and falls sharply. Because this narrow erase pulse Per1 has a pulse width shorter than that of the sustain pulse, the interval to the timing t4 has to be shortened.

In other words, the narrow erase pulse Per1 with sharp rise and fall is generated by the clamp circuit CP, without operating the power recovery circuit LC of the Y sustain drive circuit 18.

Further, by maintaining only the control pulse PLU at an L level and setting the control pulses PCU, PLD, PCD to an H level at the timings t2, t3, t4, it is possible to generate a narrow erase pulse Per2 with a sharp rise and a dull rise waveform. In this case, the intervals to the timings t3, t4 also have to be shortened so as to shorten the pulse width of the narrow erase pulse Per2.

In other words, the Y sustain drive circuits 16 generates the narrow erase pulse Per2 with a sharp rise with the clamp circuit CP alone, without operating the power recovery circuit LC, and generates the narrow erase pulse Per2 with a dull fall waveform by operating the power recovery circuit LC and clamp circuit CP.

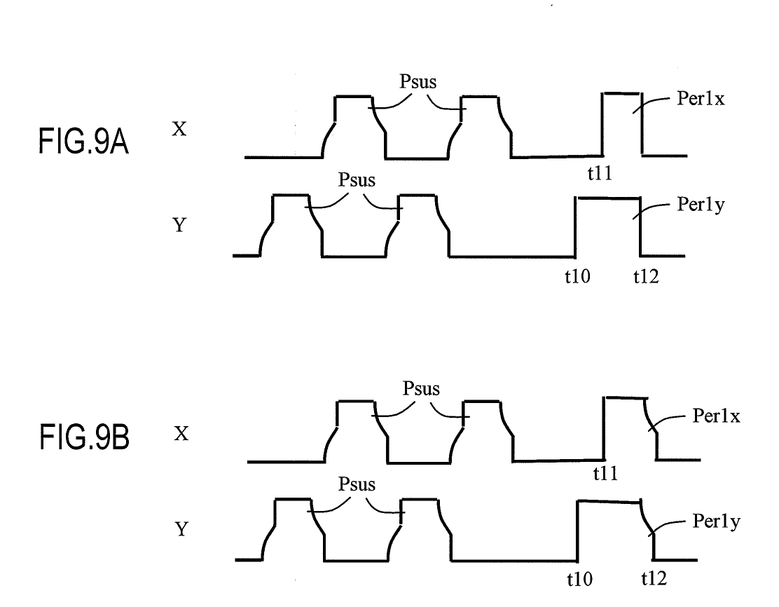

FIG. 9 shows a waveform of the second sustain pulse in the present embodiment. By providing the X, Y sustain drive circuits 20, 16 with the power recovery circuit LC, the transistor sizes of the switches CU, CD of the clamp circuit CP are made comparatively small. Therefore, where the narrow erase pulses Per1, 2 are generated by the switches CU, CD of the clamp circuit CP, the rise characteristic and fall characteristic thereof become rather gradual and it is not easy to reproduce accurately the narrow pulse width.

Accordingly, in the second sustain pulse shown in FIG. 9A, the sustain pulse Psus is identical to that shown in FIG. 7B, but the narrow erase pulse Per1 is a pulse obtained by synthesizing an Y erase pulse Per1y produced by the Y sustain driver circuit and an X erase pulse Per1x produced by the X sustain driver circuit. At the timing t10, the Y erase pulse Per1y rises sharply, at the subsequent timing t11 that is separated from the timing t10 by an interval equal to the pulse width of the narrow erase pulse, the X erase pulse Per1x rises sharply, and at the subsequent timing t12, both X, Y erase pulses Per1x, Per1y fall sharply at the same time. The erase pulses between the X, Y electrodes that are synthesized of the X, Y erase pulses Per1x, Per1y have the waveforms identical to that of the narrow erase pulse Per1 shown in FIG. 7B.

The X, Y sustain driver circuits 20, 16 can generate the aforementioned X, Y erase pulses Per1x, Per1y only by the clamp circuit CP, stopping the operation of the power recovery circuit. Moreover, the pulse width of the X, Y erase pulses Per1x, Per1y can be made comparatively large. By shortening the interval between timings t10 and t11, it is possible to make the synthesized pulse a desired pulse width.

In the second sustain pulse shown in FIG. 9B, the narrow erase pulse Per1 is also a pulse obtained by synthesizing the Y erase pulse Per1y produced by the Y sustain driver circuit and the X erase pulse Per1x produced by the X sustain driver circuit. At the timing t10, the Y erase pulse Per1y rises sharply, at the subsequent timing t11 that is separated from the timing t10 by an interval equal to the pulse width, the X erase pulse Per1x rises sharply, and at the subsequent timing t12, both X, Y erase pulses Per1x, Per1y fall sharply at the same time. The erase pulses between the X, Y electrodes that are synthesized of the X, Y erase pulses Per1x, Per1y also have the waveforms identical to that of the narrow erase pulse Per1 shown in FIG. 7B.

The X, Y sustain driver circuits 20, 16 can generate the aforementioned X, Y erase pulses Per1x, Per1y only by the clamp circuit CP, stopping the operation of the power recovery circuit. Further, the falling of the erase pulses can be generated by the power recovery circuit LC and clamp circuit CP.

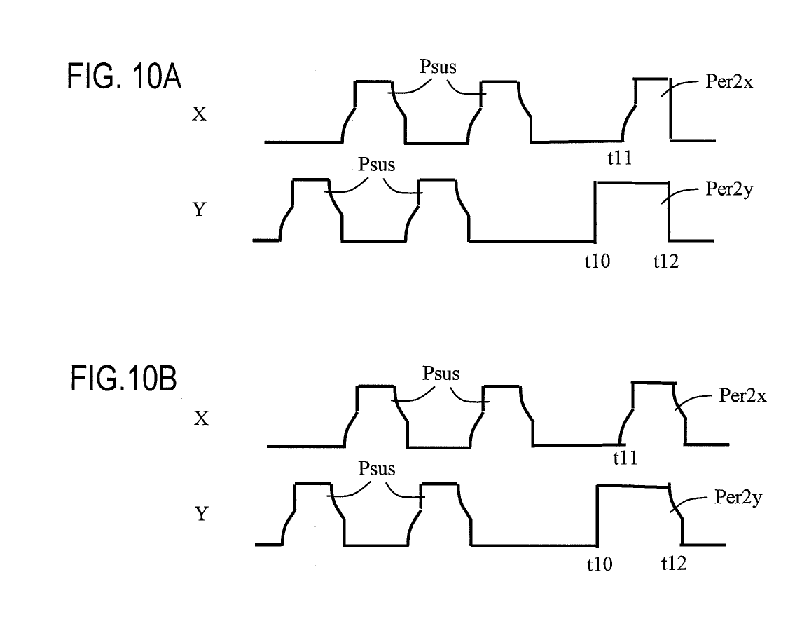

FIG. 10 shows a waveform of the third sustain pulse in the present embodiment. With such waveform of the third sustain pulse, the narrow erase pulse Per2 shown in FIG. 7C can be generated.

In the third sustain pulse shown in FIG. 10A, the sustain pulse Psus is identical to that shown in FIG. 7, but the narrow erase pulse Per2 is a pulse obtained by synthesizing an Y erase pulse Per2y produced by the Y sustain driver circuit and an X erase pulse Per2x produced by the X sustain driver circuit. At the timing t10, the Y erase pulse Per2y rises sharply, at the subsequent timing t11 that is separated from the timing t10 by an interval equal to the pulse width, the X erase pulse Per2x rises as a dull waveform, and at the subsequent timing t12, both X, Y erase pulses Per2x, Per2y fall sharply at the same time. The erase pulses between the X, Y electrodes that are synthesized of the X, Y erase pulses Per2x, Per2y have the waveforms identical to that of the narrow erase pulse Per2 shown in FIG. 7C.

The Y sustain driver circuit 18 can generate the aforementioned Y erase pulses Per2y only by the clamp circuit CP, stopping the operation of the power recovery circuit LC. Further, the X sustain driver circuit 20 can provide the X erase pulse Per2x with a rise characteristic of a dull waveform with the power recovery circuit LC and clamp circuit CP and a sharp fall characteristic with the clamp circuit CP. Moreover, the pulse width of the X, Y erase pulses Per2x, Per2y can be made comparatively large. By shortening the interval between timings t10 and t11, it is possible to make the synthesized pulse a desired pulse width.

In the third sustain pulse shown in FIG. 10B, the narrow erase pulse Per2 is also a pulse obtained by synthesizing the Y erase pulse Per2y produced by the Y sustain driver circuit and the X erase pulse Per2x produced by the X sustain driver circuit. At the timing t10, the Y erase pulse Per2y rises sharply, at the subsequent timing t11 that is separated from the timing t10 by an interval equal to the pulse width, the X erase pulse Per2x rises as a dull waveform, and at the subsequent timing t12, both X, Y erase pulses Per2x, Per2y fall as dull waveforms at the same time. The erase pulses between the X, Y electrodes that are synthesized of the X, Y erase pulses Per2x, Per2y also have the waveforms identical to that of the narrow erase pulse Per2 shown in FIG. 7C.

The power recovery circuit is stopped only when the Y erase pulse Per2y rises, and all the power recovery circuits are caused to operate by the rise of other Y erase pulses Per2y and also rise and fall of the X erase pulses Per2x. Therefore, power consumption can be reduced.

The Y sustain driver circuits 16 can raise sharply the aforementioned Y erase pulse Per2y only with the clamp circuit CP, stopping the operation of the power recovery circuit. In other cases, the fall of the Y erase pulse Per2y and rise and fall of the X erase pulse Per2x can have the waveform shown in FIG. 10B by the power recovery circuit LC and clamp circuit CP.

As described hereinabove, with the present embodiment, in the sustain period, the sustain pulse corresponding to the luminance characteristic of the subfield has a dull waveform characteristic on the rise and fall sides because of the operation of the power recovery circuit, and power consumption can be reduced. On the other hand, the narrow erase pulse following the sustain pulse application partially stops the operation of the power recovery circuit, makes the rise characteristic sharper, and can inhibit the spread in the narrow erase operation caused by the spread in cell characteristics.

What is claimed is:

1. A plasma display panel device having a plurality of display electrodes on a substrate surface, the display electrodes including first electrodes and second electrodes adjacent to each other, comprising:
drive circuits that drive the first electrodes and second electrodes, wherein
in a sustain period, the drive circuits apply sustain pulses having a rising dull waveform during the rise and a falling dull waveform during the fall between the first and second electrodes a plurality of times, and after the plurality of sustain pulses have been applied, apply narrow erase pulses having a rise characteristic sharper than the rising dull waveform during the rise and also having a pulse width shorter than that of the sustain pulses between the first and second electrodes.

2. The plasma display panel device according to claim 1, wherein the narrow erase pulse has the falling dull waveform during the fall.

3. The plasma display panel device according to claim 1, wherein the drive circuits each have a power recovery circuit comprising an LC resonance circuit, and a clamp circuit that applies a clamp voltage between the first and second electrodes, and
the drive circuits apply a rising dull waveform voltage with operating the power recovery circuit between the first and second electrodes, then apply the clamp voltage with operating the clamp circuit during the rise of the sustain pulse; apply a falling dull waveform voltage with operating the power recovery circuit, then remove the clamp voltage of the clamp circuit during the fall; and apply the clamp voltage with operating the clamp circuit without operating the power recovery circuit during the rise of the narrow erase pulse.

4. The plasma display panel device according to claim 3, wherein the drive circuits apply the falling dull waveform voltage with operating the power recovery circuit and then remove the clamp voltage of the clamp circuit during the fall of the narrow erase pulse.

5. A plasma display panel device having a plurality of display electrodes on a substrate surface, the display electrodes including first electrodes and second electrodes adjacent to each other, comprising:
a first electrode drive circuit that drives the first electrodes; and
a second electrode drive circuit that drives the second electrodes, wherein
in a sustain period, the first and second electrode drive circuits alternately apply sustain pulses having a rising dull waveform during the rise and a falling dull waveform during the fall to the first and second electrodes, and
after the sustain pulses have been applied to the second electrodes, the first electrode drive circuit applies, to the first electrodes, narrow erase pulses having a rise characteristic sharper than the rising dull waveform during the rise and also having a pulse width shorter than that of the sustain pulses.

6. The plasma display panel device according to claim 5, wherein the first and second electrode drive circuits each have a power recovery circuit comprising an LC resonance circuit, and a clamp circuit that applies a clamp voltage to the first and second electrodes,
the first and second electrode drive circuits apply a rising dull waveform voltage with operating the power recovery circuit, then apply the clamp voltage with operating the clamp circuit during the rise of the sustain pulses applied alternately to the first and second electrodes; and apply a falling dull waveform voltage with operating the power recovery, and then remove the clamp voltage of the clamp circuit during the fall, and
the first electrode drive circuit applies the clamp voltage with operating the clamp circuit during the rise of the narrow erase pulse without operating the power recovery circuit.

7. The plasma display panel device according to claim 6, wherein the first electrode drive circuit applies the falling dull waveform voltage with operating the power recovery circuit and then removes the clamp voltage of the clamp circuit during the fall of the narrow erase pulse.

8. A plasma display panel device having a plurality of display electrodes on a substrate surface, the display electrodes including first electrodes and second electrodes adjacent to each other, comprising:
a first electrode drive circuit that drives the first electrodes; and
a second electrode drive circuit that drives the second electrodes, wherein
in a sustain period, the first and second electrode drive circuits alternately apply sustain pulses having a rising dull waveform during the rise and a falling dull waveform during the fall to the first and second electrodes, and
after the sustain pulses have been applied to the second electrodes, the first electrode drive circuit applies a first erase pulse having a rise characteristic sharper than the rising dull waveform to the first electrodes at a first time, and the second electrode drive circuit applies a second erase pulse of the same polarity as the first erase pulse to the second electrodes at a second time after a time shorter than a pulse width of the sustain pulse has elapsed from the first time.

9. The plasma display panel device according to claim 8, wherein the first erase pulse has the falling dull waveform at a third time after the second time, and
the second erase pulse has the falling dull waveform at the third time.

10. The plasma display panel device according to claim 8, wherein the second erase pulse has the rising dull waveform at the second time.
